(19) United States
(12) Patent Application Publication
(10) Pub. No.: US 2023/0285987 A1
(43) Pub. Date: Sep. 14, 2023

(54) AN ENCLOSED CENTRIFUGATION DEVICE AND A METHOD FOR SEGREGATING CELLS

(71) Applicant: SUZHOU ETTA BIOTECH CO., LTD., Suzhou, Jiangsu (CN)

(72) Inventor: Edward Dai, Suzhou, Jiangsu (CN)

(21) Appl. No.: 18/018,159

(22) PCT Filed: Sep. 26, 2021
(86) PCT No.: PCT/CN2021/120714

§ 371 Date: Jan. 26, 2023

(30) Foreign Application Priority Data
Jul. 27, 2020 (CN) 202010726898.6

(51) Int. Cl. B04B 5/04; B01D 17/02; B01D 21/26

(52) U.S. Cl. CPC B04B 5/0414; B01D 17/0217; B01D 21/262; B01L 2200/0684; B01L 2400/0409; B04B 2005/0478

(57) ABSTRACT

An enclosed centrifugation device is provided, including an integrated tube body that includes an upper part, a middle part, and a lower part, wherein the upper part is configured to have multiple openings each having an open state and a closed state. The openings that are used for sealed connection to external tubing, include the first opening serving as a liquid inlet and the second opening serving as a liquid outlet. Also provided is a method for segregating cells. The enclosed centrifugation device provided by the present invention can centrifuge cell suspension and realize rapid inlet, outlet, or replacement of liquid in an enclosed setting, which greatly reduces the risk of being contaminated for biological sample, and simultaneously meets the requirement by regulations that sample treatment by Class III medical devices must be fully enclosed.

### CROSS REFERENCE TO RELATED APPLICATIONS

This application claims priority to PCT Application No. PCT/CN2021/120714, having a filing date of Sep. 26, 2021, which claims priority to CN Application No. 202010726898.6, having a filing date of Jul. 27, 2020, the entire contents both of which are hereby incorporated by reference.

### FIELD OF TECHNOLOGY

The following relates to an enclosed centrifugation device, and more specifically, to a device for segregating cells from cell culture medium in an enclosed setting and a method for segregating cells by using the device.

### BACKGROUND

A centrifugation tube is defined as a tubular liquid container that can be used for centrifugation, and it has been widely used in the biological research, especially cell and molecular biology and biochemistry. Centrifugation technology is mainly used for segregation and preparation of various biological sample. Under the high-speed rotation (of a centrifuge), due to the impact of huge centrifugation force, tiny particles (such as cells, molecules) in biological sample suspension in the centrifugation tube, are forced to move down at a certain speed to the bottom of the centrifugation tube and accumulate at the bottom of the centrifugation tube, and to form a compact clump, so as to segregate from the solution. The centrifugation tube is an indispensable structural component of the centrifugation technology, and centrifugation tubes of different specifications and styles can be selected and used to achieve different centrifugation purposes.

In biological experiments, it is frequently required to wash cells, replace culture medium or other liquid, that often involves a centrifugation procedure. In traditional centrifugation operation, a technician usually pours liquid such as cell suspension or supernatant into and out of a centrifugation tube or from a centrifugation tube to other containers, therefore the opening of a standard centrifugation tube is an opening with the same diameter as the body of the centrifugation tube, so that it is easier to transfer liquid in and out frequently. The above-mentioned operation of liquid transfer is carried out in a clean bench, while the centrifuge is located in an open environment, so as the entire centrifugation process, thus biological samples to be centrifuged are under a risk of being contaminated. Especially in the preparation of immune cells for clinical treatment of cancer, it is essential to completely eliminate the above-mentioned potential contamination risk to meet the zero contamination standard set by regulatory authorities.

Therefore, there is an urgent need for a centrifugation device that can be used in an enclosed and sterile settings, to meet the needs of the above-mentioned applications.

On the market, the BIOSAFE centrifugation system can perform centrifugation in the above-mentioned enclosed setting, while it can only achieve the result of cell layer-distribution but not cell segregation by centrifugation, that is, cells cannot be completely segregated from their reagent liquid. In many applications such as cell electrotransfection, replacement of cell culture medium with electroporation buffer prior to electrotransfection requires complete discard of supernatant/liquid, i.e. cells must form a solid, not-easy-dispersible cell clump that can be segregated from liquid, to reach the goal of complete segregation of cells from liquid. In addition, cell segregation is a necessary step for accurate control of cell density in cell suspension, when the conductivity of cell suspension can also be regulated to improve electrotransfection efficiency and cell viability.

Specifically, we need to design a novel enclosed centrifugation device that can completely segregate cells in an enclosed and sterile setting.

The existing patent CN201721562489.7 provided an improved sampling device, wherein the bioreactor and the sampling device are operated in a sterile state during multiple sampling or continuous sampling process, by the impact of air pressure to improve sampling efficiency in the process of biological reaction tests. However, in the process of sterile sampling, the pressure in the bioreactor needs to be increased first and then pressure at the position of the second tube to be increased, which makes the operation complicated. In addition, the entire device includes a centrifugation tube, a first tube, and a second tube. The centrifugation tube, the sealed cover of which is configured to have a first hole and a second hole, is not an integrated tube body structure, therefor liquid in the tube has still a risk of being contaminated.

Another patent CN201721017811.8 provided a sterile centrifugation tube kit capable of maintaining the centrifugation tube sterile, comprising an external tube and an internal tube as a whole. The entire invention aims to keep the external tube sterile and closed before and after centrifugation, which is conducive to the various sterile operations after centrifugation. However, the internal tube, including a tube body, an internal tube plug, a sealed cap and an internal tube attachment, is not an integrated tube body structure. During operation of liquid injection, the sealed cap and the inner tube plug need to be opened/closed, and therefor raised a risk for fluid in the tube of being contaminated.

In view of application limitations of the above-mentioned conventional art, embodiments of the present invention propose a novel enclosed centrifugation device that can be used in conjunction with an existing centrifuge to completely segregate cells by centrifugation in an enclosed setting.

### SUMMARY

An aspect relates to an enclosed centrifugation device.

In order to achieve the above-mentioned aspect, the technical solution of the enclosed centrifugation device provided by embodiments of the present invention is summarized as followis:

An enclosed centrifugation device, comprises an integrated tube body that includes an upper part, a middle part and a lower part, wherein two ends of the middle part are fixed connected to the upper part and the lower part respectively, or, the upper part, the middle part and the lower part are integrally injection molded, and the upper part is configured to have multiple openings that are used for sealed connection to external tubing and include,
the first opening serving as a liquid inlet having an open state and a closed state, which is used for sealed connection to a liquid inlet tube,
and the second opening serving as a liquid outlet having an open state and a closed state, which is used for sealed connection to a liquid outlet tube.

The enclosed centrifugation device in an embodiment of the present invention, includes a tube body that is configured to have at least three openings, the first opening serving as a liquid inlet, the second opening serving as a liquid outlet, and the third opening serving as a vent having an open state and a closed state, which is used for sealed connection to an air filtering device such as an air filter, so as to filter the air that enters the centrifugation device to prevent the centrifugation device from being contaminated. The upper part is cone-shaped protruding upward, wherein the second opening is located at the tip of the cone as the upper part, and the first opening and the third opening are located on the side wall of the cone as the upper part. In an embodiment, the first opening and the third opening are located on one side of the second opening respectively, in which case the three openings are projected on a straight line onto the horizontal plane, or, the first opening and the third opening are located on the same side of the second opening, in which case the three openings are projected as the three vertices of a triangle onto the horizontal plane.

In an embodiment, the upper part and/or the lower part is cone-shaped, and the middle part is cylinder-shaped.

In an embodiment, the upper part is cone-shaped protruding upward, or, the top of the upper part is flat or spherical.

In an embodiment, the lower part is cone-shaped protruding downward.

In an embodiment, the upper part and the lower part are both cone-shaped.

In an embodiment, the upper part is cone-shaped protruding upward and the lower part is cone-shaped protruding downward.

In an embodiment, the first opening, the second opening and the third opening are all configured on the cone as the upper part.

In an embodiment, the second opening is located at the tip of the cone as the upper part.

In an embodiment, the upper part is cone-shaped protruding upward and the second opening is located at the tip of the cone as the upper part.

In an embodiment, the upper part is cone-shaped protruding upward, the second opening is located at the tip of the cone as the upper part, and the first opening and the third opening are located on the side wall of the cone as the upper part.

In an embodiment, the inner part of the tube body is configured to have a protrusion, which is used to block cell clumps in the tube body.

In an embodiment, the lower part is cone-shaped protruding downward, the side wall of the cone as the lower part is configured to have a protrusion serving as a barrier, which is used to prevent the cell clumps (especially some sand-like, discrete cells) near the tip of the cone as the lower part from sliding down the tube wall to the second opening, when in a liquid-outflow state.

In an embodiment, the protrusion is distributed along the horizontal plane, the width of the protrusion ranges between 0.2 cm-1.5 cm, and the length of the protrusion ranges between ⅓ - ½ of the circumference of the tube body at corresponding position of the protrusion.

In an embodiment, the width of the protrusion is about 0.6 cm, and the length of the protrusion is about ⅓ of the circumference of the tube body at the corresponding position of the protrusion.

In an embodiment, each of the openings is equipped with a valve respectively, which controls the corresponding opening to switch between the open state and the closed state.

In an embodiment, the valve can be selected from a check valve, a hose clamp, etc., and the first opening, the second opening and the third opening have sealed connection to external tubing, the type of which includes tube joint connection or hot melting connection, wherein the tube joint is selected from one or more kinds of a quick joint, an impermeable joint and a sterile joint, and the quick joint is selected from one or more kinds of a needle-free joint and a Luer taper.

In an embodiment, the enclosed centrifugation device further includes protective caps, and the openings are sealed connected to the corresponding protective caps respectively in a detachable way such as thread connection, snap connection.

In an embodiment, the enclosed centrifugation device further includes a protective cover, which is connected to the tube body, and when the protective cover is connected to the tube body, the openings are located inside the protected space between the protective cover and the tube body.

The protective cover is connected to the middle part, and the upper part is located in the protective space. In an embodiment, the tube body is sealed or fixedly connected to the protective cover in a detachable way such as thread connection, snap connection, etc.

In an embodiment, the tube body is integrally embedded inside the protective cover.

In an embodiment, the tube wall of the tube body is fit with the tube wall of the protective cover, and the inner cavity of the protective cover is similar to the shape of the tube body.

In an embodiment, the height of the protective cover is greater than that of the tube body, and when the tube body is embedded in the protective cover, the openings and the protection caps are completely placed inside the protective cover.

When manufacturing the tube body of embodiments of the present invention, it could be divided first into at least two parts that are then injection molded respectively, and are finally assembled into a whole by hot melting, welding or other processes.

In an embodiment, the tube body, the openings, and the tube joints are integrally injection molded.

In some embodiments, the tube body is configured to have a liquid suction tube, one end of which is connected to the liquid outlet, and one end of the liquid suction tube is sealed connected to the liquid outlet.

In an embodiment, the lower part is cone-shaped protruding downward, and the other end of the liquid suction tube is located at the junction of the middle part and the lower part, or, the other end of the liquid suction tube is located on the side wall of the cone as the lower part. When the enclosed centrifugation device is tilted until the bottom end of the liquid suction tube is at the lowest point of liquid, it ensures that liquid is sucked up and segregated from cells completely. Furthermore, the liquid suction tube combining with the protrusion serving as a barrier, achieves better segregation of fluid from cells.

In an embodiment, the liquid outlet is the fourth opening located at the upper part.

In an embodiment, the fourth opening is configured to have the liquid suction tube.

In an embodiment, the tube body is configured to have the liquid suction tube, one end of which is sealed connected to the fourth opening.

In an embodiment, the liquid suction tube and the fourth opening are sealed connected by sealant connection, ultrasonic welding connection, etc., and the liquid suction tube and the side wall of the tube body are fixed connected by adhesive connection, etc.

In an embodiment, the other end of the liquid suction tube is located at the side wall of the cone as the lower part.

In an embodiment, the other end of the liquid suction tube is located at the junction of the middle part and the lower part.

In an embodiment, the fourth opening is sealed to a collection device.

In an embodiment, the fourth opening is sealed connected to the collection device by a liquid suction tube.

In an embodiment, the collection device is a negative pressure collection device.

In an embodiment, the negative pressure collection device can be selected from a syringe, a pipette, a container with a negative pressure pump, etc.

In an embodiment, the tube body is made of hard material and/or soft material, and the protective cover is made of hard material and/or soft material.

In an embodiment, the hard material is selected from ceramics, glass, ABS, PC, PS, PA, POM, PMMMA and other non-deformable materials.

In an embodiment, the soft material is selected from silicone, rubber, PET, PE, PP, PVC, TPU, PU, PPS, TPE and other deformable materials.

In an embodiment, the tube body is made of soft material that is selected from silicone, rubber, PET, PE, PVC, TPU, PPS and TPE, and the enclosed centrifugation device does not include the third opening serving as a vent.

In an embodiment, the tube body is made of soft material that is selected from silicone, rubber, PET, PE, PP, PVC, TPU, PU, PPS and TPE, and the enclosed centrifugation device further comprises a protective cover that is detachably connected to the tube body, or the tube body is integrally embedded inside the protective cover, and the tube body is fit with the protective cover.

In an embodiment, at least one connecting part is placed between the protective cover and the tube body to achieve detachable connection between the protective cover and the tube body, wherein one end of the connecting part is connected to the protective cover, and the other end of the connecting part is detachably connected to the tube body. In some embodiments, the opening is configured to have a step edge, where connection between the other end of the connecting part and the tube body is located.

The protective cover is configured to have a fixing structure, with which one end of the connecting part is connected to the protective cover.

The fixing structure is a hole located on the protective cover, or, the fixing structure is a hook or a fixing base that is fixed connected to the protective cover.

The connecting part is selected from a string, a cable tie, a magic tape, a clasp, etc.

Embodiments of the present invention further provide a method for cell segregation by using an enclosed centrifugation device, including using any one of the above-mentioned enclosed centrifugation devices, in which the centrifugation force ranges between 200-500 g, so as to meet different application requirements. During centrifugation, the lower part of the tube body is farther away from the centrifugation rotation center than the upper part of the tube body, making cells to be segregated enriched in the lower part of the tube body.

Specifically, all openings of the enclosed centrifugation device are in a closed state and are configured to have a protective cap respectively. The protective cover is fixed connected to the tube body, and the openings are located inside the protected space between the protective cover and the tube body. The method consists of following steps:

1^{st} removal of protection: the protective cover and the protective cap on the first opening are removed in sequence.

Liquid inlet: the first opening is sealed connected to one end of the liquid inlet tube, the other end of which is sealed connected to a sample container. The first opening is switched to the open state, and liquid sample to be centrifuged enters the tube body from the sample container passing through the liquid inlet tube.

After liquid inlet: the first opening is switched to the closed state, and the liquid inlet tube is removed from the first opening.

2^{nd} re-protection: the protective cap is set back on the first opening. The protective cover is fixed connected to the tube body, and the openings are located inside the protected space between the protective cover and the tube body.

Centrifugation: the enclosed centrifugation device is placed in a centrifuge for centrifugation. After centrifugation operation, the entire centrifugation device is removed from the centrifuge.

2^{nd} removal of protection: the protective cover and the protective cap on the second opening are removed in sequence.

Liquid outlet: the second opening is sealed connected to one end of the liquid outlet tube, the other end of which is sealed connected to a collection container. The second opening is switched to the open state, and the tube body is tilted so that liquid in the tube body after centrifugation passes through the second opening and the liquid outlet tube successively, and finally enters the collection container.

After liquid outlet: the second opening is switched to the closed state, and the liquid outlet tube is removed from the second opening.

3^{rd} re-protection: the protective cap is set back on the second opening. The protective cover is fixed connected to the tube body, and the openings are located inside the protected space between the protective cover and the tube body.

The opening is switched between an open state and a closed state by the corresponding valve, which is not needed if the joint adopts a needle-free joint.

In some embodiments, the openings further include the third opening serving as a vent, which is in a closed state and configured to have a protective cap.

In the step of “1^{st} removal of protection”, the protective cap on the third opening is removed.

In the step of “Liquid inlet”, the third opening is sealed connected to the air filtering device used for filtering air that enters the tube body from outside, and the third opening is switched to the open state.

In the step of “After liquid inlet”, the third opening is switched to the closed state, and the air filtering device is removed from the third opening.

In the step of “2^{nd} re-protection”, the protection cap is set back on the third opening.

In the step of “2^{nd} removal of protection”, the protective cap on the third opening is removed.

In the step of “Liquid outlet”, the third opening is sealed connected to the air filtering device used for filtering air that enters into the tube body from the outside, and after the second opening is switched to the open state, the third opening is switched to the open state.

In the step of “After liquid outlet”, the third opening is switched to the closed state, and the air filtering device is removed from the third opening.

In the step of “3^{rd} re-protection”, the protection cap is set back on the third opening.

Embodiments of the present invention further provide another method for cell segregation by using an enclosed centrifugation device, including any one of the above-mentioned enclosed centrifugation devices, of which all openings are in a closed state and are configured to have a protective cap respectively. The protective cover is fixed connected to the tube body, and the openings are located inside the protected space between the protective cover and the tube body. The method consists of following steps:

1^{st} removal of protection: the protective cover and the protective caps on the first opening and the third opening are removed in sequence.

Liquid inlet: the first opening is sealed connected to one end of a liquid inlet tube, the other end of which is sealed connected to a sample container. The third opening is sealed connected to an air filtering device used for filtering air that enters the tube body from outside. The first opening and the third opening are switched to the open state respectively, and liquid sample to be centrifuged enters the tube body from the sample container passing through the liquid inlet tube.

After liquid inlet: the first opening and the third opening are switched to the closed state respectively. The liquid inlet tube is removed from the first opening, and the air filtering device is removed from the third opening.

2^{nd} re-protection: the protection caps are set back on the first opening and the third opening respectively. The protective cover is fixed connected to the tube body, and the openings are located inside the protected space between the protective cover and the tube body. The protective cover is fixed connected to the tube body by a connection part such as a string, a cable tie, a magic tape, a clasp, and the fixing structure on the protective cover is a hole, or a hook or a fixing base that is fixed connected to the protective cover by thread connection. One end of the connection part is connected to the fixing structure, and the other end of the connection part is connected to the step edge at the upper opening of the tube body.

Centrifugation: the enclosed centrifugation device is placed in a centrifuge for centrifugation. After centrifugation operation, the entire centrifugation device is removed from the centrifuge.

2^{nd} removal of protection: the protective cover, the connecting part, and the protective caps on the fourth opening and the third opening are removed in sequence, and the fourth opening is sealed connected to the liqui suction tube in the tube body.

Liquid outlet: the fourth opening is sealed connected to one end of the liquid outlet tube, the other end of which is sealed connected to a negative pressure collection device. The third opening is sealed connected to an air filtering device used for filtering air that enters into the tube body from outside. The third opening and the fourth opening are switched to the open state respectively, and the tube body is tilted so that liquid in the tube body after centrifugation passes through the fourth opening and the liquid outlet tube successively, and finally enters the negative pressure collection device.

After liquid outlet: the third opening and the fourth opening are switched to the closed state respectively, the air filtering device is removed from the third opening, and the liquid outlet tube is removed from the fourth opening.

3^{rd} re-protection: the protective caps are set back on the third opening and the fourth opening respectively. The protective cover is fixed connected to the tube body, and the openings are located inside the protected space between the protective cover and the tube body.

In an embodiment, the types of cell to be used for centrifugation mainly include cells used for clinical treatment of cancer such as PBMC, various types of immune cells (for example, tranquillization state or activated T cells, NK cells, DC cells, stem cells), various types of engineered cells such as CHO-S cells, HEK293 cells, and various other biological cells.

The above-mentioned term “cell layer-distribution”, refers to centrifugation or vortex of cell suspension according to density gradient by adding separation liquid (meaning different kinds of liquid). After centrifugation or vortex of cell suspension, liquid layers of different densities are formed, and cells of different densities are distributed in liquid layers of corresponding densities, thus segregating different cells. Layer-distributed cells are enriched to a certain level, but is still in certain dispersion state because they are suspended in liquid, and cannot be completely segregated from liquid.

The above-mentioned term “cell enrichment”, refers to that cells are highly enriched by means such as centrifugation to form solid clumps in the liquid (referring to a single type of liquid), which are not dispersed in liquid and can be completely segregated from liquid.

The above-mentioned term “joint”, refers to a common tube joint used in medical tubing connection, aiming to ensure a rapid, safe and impermeable biological operating environment. A tube joint without a built-in a soft plug or a rubber plug, one kind of which is the common Luer taper, is called a “quick j oint”, and thus the tubing connection can be opened or closed without use of a tool. A tube joint with a built-in a soft plug or a rubber plug is called a “needle-free joint”. When a needle-free joint is screwed into a tube, the core in the middle of one end of the joint pushes apart the built-in soft plug or the rubber plug at the other end, and the tubing connection is opened. When a needle-free joint is screwed out of a tube, the soft plug or the rubber plug returns to the original position, and the tube connection is closed. In other words, if a needle-free joint is used, there is no need for a control valve.

Compared with the conventional art, embodiments of the invention have the beneficial technical effects that:

The enclosed centrifugation device of embodiments of the present invention can be used for centrifugation of cell suspension in an enclosed setting, to achieve rapid inlet, outlet or replacement of liquid, which greatly reduces the risk of being contaminated for sample.

The enclosed centrifugation device of embodiments of the present invention can achieve cell enrichment result, compared to cell suspension in a state of cell layer-distribution, which can segregate cells from liquid that need to be abandoned completely, and in electrotransfection application, ensures non-dilution of electrotransfection buffer and more accurate control of cell density, thus achieving higher electrotransfection efficiency and higher cell viability. The upper part and the lower part of the tube body of the enclosed centrifugation device of embodiments of the present invention are both cone-shaped, wherein the cone as the upper part is configured to discharge liquid from the tip of the cone, the least amount remaining in the tube body, while the cone as the lower part is configured to obtain higher cell enrichment when cells are centrifugally enriched, to form solid cell clumps at the tip of the cone.

The liquid outlet of the enclosed centrifugation device of embodiments of the present invention is located at the tip of the cone as the upper part, which ensures that, in a liquid-outflow state, when increasing inclination of the tube body, cell suspension, buffer, or other mixed liquid, etc. in the tube always gathers near the liquid outlet, so that cell suspension, buffer, or other mixed liquid, etc. can be completely discharged.

The side wall of the cone as the lower part of the tube body of the enclosed centrifugation device of embodiments of the present invention is configured to have a protrusion (barrier), which is used to prevent cell clumps (especially some sand-like and discrete cells) enriched near the tip of the cone as the lower part from sliding down the tube wall to the liquid outlet in a liquid-outflow state.

In the enclosed centrifugation device of embodiments of the present invention, liquid can be sucked in and discharged through deformation of the tube body that is made of soft material, and therefore there is no need to design a vent and no need for an air-filtering device, thus simplifying the structure of the entire device.

The enclosed centrifugation device of embodiments of the present invention can be used with a conventional, general commercial centrifuge in the market, without the need to customize or redesign a centrifuge or a centrifugation tube bracket.

The enclosed centrifugation device of embodiments of the present invention adopts tube joints with internal and external threads, wherein the tube joint at the liquid-outlet end is equipped with an external thread and the tube joint at the liquid-inlet end is equipped with an internal thread, which ensures that the liquid always flows through the inner wall of the tube joint, avoiding liquid residue at the joint as much as possible and reducing the risk of biological sample being contaminated.

Protective caps and the protective cover of the enclosed centrifugation device of embodiments of the present invention play a role of multiple protection as much as possible, which greatly reduce the risk of biological sample being contaminated. After each tube is removed, the corresponding opening is configured to have a protective cap. The height of the protective cover is greater than the height of the tube body. All liquid and/or air openings on the tube body are placed inside the protective cover, and are completely located in the protected space between the protective cover and the tube body, which not only maximally avoids each tube joint being touched by human hands, but also ensures the smooth completion of the entire centrifugation process.

Core function of the enclosed centrifugation device of embodiments of the present invention is to realize “liquid inlet → centrifugation → liquid outlet” process for one or many times in an enclosed environment, so as to ensure sterility and significant improvement of safety of the whole process, and to maximally reduce the risk of being contaminated for biological sample, which meets the requirement by regulations that sample treatment by Class III medical devices must be fully enclosed. The enclosed centrifugation device of embodiments of the present invention can be used in all occasions when enclosed centrifugation is required. The enclosed centrifugation device of embodiments of the present invention can be used for cell treatment in electrotransfection application and in many other applications, such as that cell culture can be performed directly after liquid-outlet operation by using the enclosed centrifugation device if the collection container is a cell culture bag.

### BRIEF DESCRIPTION

Some of the embodiments will be described in detail, with references to the following

Figures, wherein like designations denote like members, wherein:

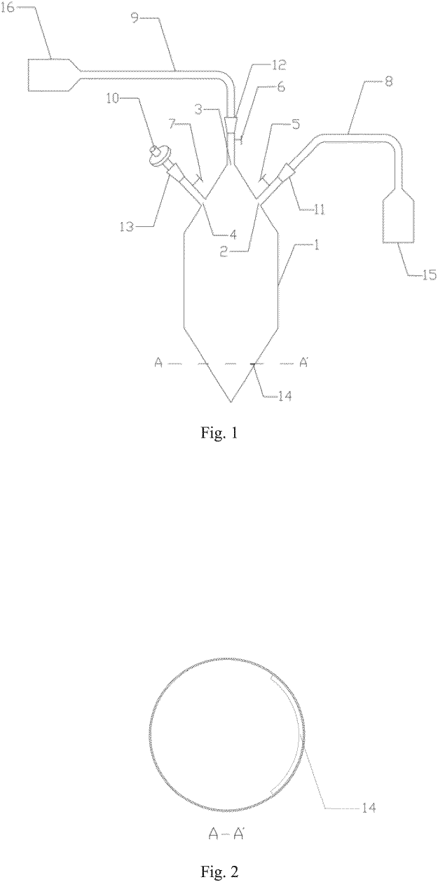

FIG. 1 shows a schematic diagram of an overall structure of an enclosed centrifugation device in Embodiment 1 of the present invention;

FIG. 2 shows a top view of the protrusion (barrier) in the AA’ cross section in FIG. 1;

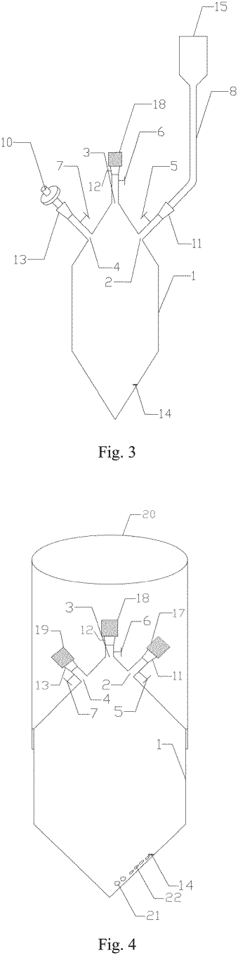

FIG. 3 shows a schematic diagram of an enclosed centrifugation device in a liquid-inletting state in Embodiment 1 of the present invention;

FIG. 4 shows a schematic diagram of an enclosed centrifugation device in an initial state/a centrifugation state in Embodiment 1 of the present invention;

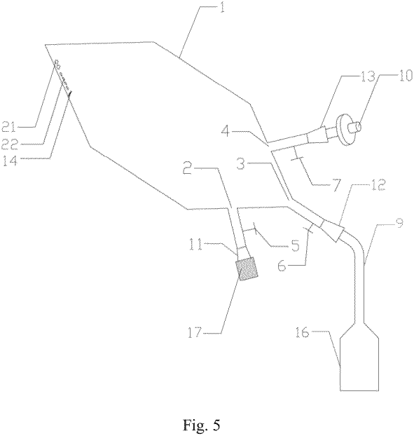

FIG. 5 shows a schematic diagram of an enclosed centrifugation device in a liquid-outflow state in Embodiment 1 of the present invention;

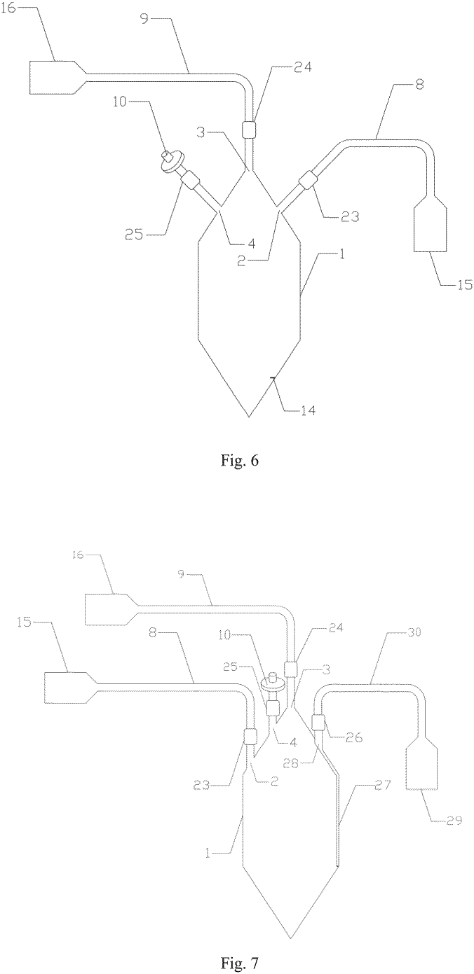

FIG. 6 shows a schematic diagram of another overall structure of an enclosed centrifugation device in Embodiment 1 of the present invention;

FIG. 7 shows a schematic diagram of an overall structure of an enclosed centrifugation device in Embodiment 3 of the present invention;

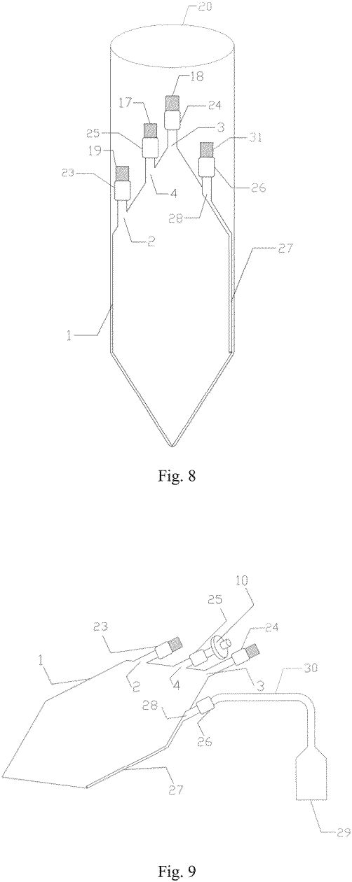

FIG. 8 shows a schematic diagram of an enclosed centrifugation device in an initial state/a centrifugation state in Embodiment 3 of the present invention;

FIG. 9 shows a schematic diagram of an enclosed centrifugation device in a liquid-outflow state in Embodiment 3 of the present invention;

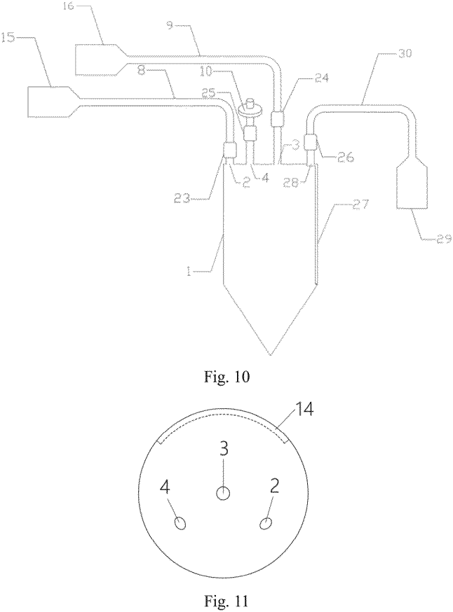

FIG. 10 shows a schematic diagram of an overall structure of an enclosed centrifugation device in Embodiment 4 of the present invention;

FIG. 11 shows a top view of the tube body of an enclosed centrifugation device in Embodiment 5 of the present invention.

Wherein: 1, tube body, 2, first opening, 3, second opening, 4, third opening, 5, first valve, 6, second valve, 7, third valve, 8, liquid inlet tube, 9, liquid outlet tube, 10, air filte (air filtering device), 11, first Luer taper, 12, second Luer taper, 13, third Luer taper, 14, protrusion (barrier), 15, sample container, 16, collection container, 17, first protective cap, 18, second protective cap, 19, third protective cap, 20, protective cover, 21, cell clump, 22, sand-like and discrete cells, 23, first needle-free joint, 24, second needle-free joint, 25, third needle-free joint, 26, fourth needle-free joint, 27, liquid suction tube, 28, fourth opening, 29, negative pressure collection device, 30, liquid suction tube, 31, fourth protective cap.

### DETAILED DESCRIPTION

The technical solutions in the embodiments of the present invention are described clearly and completely below. Obviously, the described embodiments are only a part of the embodiments of the present invention, rather than all embodiments. Based on the embodiments of the present invention, all other embodiments obtained by those of ordinary skill in the conventional art without creative efforts shall fall within the protection scope of embodiments of the present invention. The terms “horizontal”, “upper”, “middle”, “lower”, etc. in relation to orientation in embodiments of the present invention, refer to the expressions made for convenience of clearly describing relevant technical solutions when the tube body is placed vertically, which does not constitute a corresponding limitation on scope protection of embodiments of the present invention, hereby declared.

### Embodiment 1

The present embodiment provides an enclosed centrifugation device (FIGS. 1-6), comprising an integrated tube body 1 that includes an upper part, a middle part and a lower part, wherein two ends of the middle part are fixed connected to the upper part and the lower part respectively, or, the upper part, the middle part and the lower part are integrally injection molded, and the upper part is configured to have multiple openings that are used for sealed connection to external tubing, and include,

The first opening 2 serving as a liquid inlet having an open state and a closed state, which is used for sealed connection to a liquid inlet tube 8 The second opening 3 serving as a liquid outlet having an open state and a closed state, is used for sealed connection to a liquid outlet tube 9. The openings in the present embodiment further includes the third opening 4 serving as a vent having an open state and a closed state, which is used for sealed connection to the air filter 10 as an air filtering device. Specifically, the overall structure of the enclosed centrifugation device with three openings are shown in FIG. 1, FIG. 4 and FIG. 6.

The enclosed centrifugation device comprises a tube body 1, the first opening (liquid inlet) 2, the second opening (liquid outlet) 3, the third opening (vent) 4, the first valve 5, the second valve 6, the third valve 7, the liquid inlet tube 8, the liquid outlet tube 9, the air filter 10, the first Luer taper 11, the second Luer taper 12, the third Luer taper 13, the protrusion (barrier) 14, the sample container 15, the collection container 16, the first protective cap 17, the second protective cap 18, the third protective cap 19 and the protective cover 20. In the present embodiment, if the first Luer taper 11, the second Luer taper 12, and the third Luer taper 13 are correspondingly replaced with the first needle-free joint 23, the second needle-free joint 24, and the third needle-free joint 25, the first valve 5, the second valve 6, and the third valve 7 can be correspondingly omitted (FIG. 6).

The upper part of the tube body 1 is cone-shaped protruding upward, the lower part is cone-shaped protruding downward, and the middle part is cylinder-shaped. The tube body 1 or the protective cover 20 is made of hard material and/or soft material, both of which in the present embodiment are hard material that is selected from ceramics, glass, ABS, PC, PS, PA, POM, PMMMA, etc.

The first opening 2, the second opening 3 and the third opening 4 are all configured on the same side of cone of the tube body 1 (i.e. the cone as the upper part) the second opening 3 is located at the tip of the cone as the upper part, and the first opening 2 and the third opening 4 are located on the side wall of the cone as the upper part, and the first opening 2 and the third opening 4 are located on one side of the second opening 3 respectively.

The inner part of the tube body 1 is configured to have at least one protrusion 14, which in the present embodiment is distributed along a horizontal plane, located at the corresponding position below the second opening 3, and used to block cell clumps 21 in the tube body 1, which consequently makes the protrusion 14 serving as a barrier prevent cell clumps 21 from sliding down to the second opening 3 along with liquid when liquid is poured. In the present embodiment, the side wall of the cone as the lower part of the tube body 1 is configured to have a protrusion 14 (FIG. 2), which is used to prevent the cell clumps 21 (especially some sand-like and discrete cells 22) near the tip of the cone as the lower part from sliding down the tube wall to the second opening 3, in a liquid-outflow state. The width of the protrusion 14 ranges between 0.2 cm-1.5 cm, and the length of the protrusion 14 ranges between ⅓ - ½ of the circumference of the tube body 1 at corresponding position of the protrusion 14. In the present embodiment, the width of the protrusion 14 is about 0.6 cm, and the length of the protrusion 14 is about ⅓ of the circumference of the tube body 1 at the corresponding position of the protrusion 14.

Each of the openings are equipped with a valve respectively, which controls the corresponding opening to switch between the open state and the closed state. In the present embodiment, the first opening 2, the second opening 3 and the third opening 4 are correspondingly configured to have the first valve 5, the second valve 6 and the third valve 7 respectively, which can independently control the opening and closing of the first opening 2, the second opening 3 and the third opening 4; The first valve 5, the second valve 6 and the third valve 7 can be a check valve, or a hose clamp, etc.

The opening is sealed connected to external tubing by tube joint connection or hot melting connection, wherein the tube joint is selected from one or more kinds of a needle-free joint and a Luer taper. In the present embodiment, the tube body 1 and the tube joints are integrally injection molded.

The first opening 2 is sealed connected to one end of the liquid inlet tube 8 by the first Luer taper 11, the other end of which is sealed connected to the sample container 15. The second opening 3 is sealed connected to one end of the liquid outlet tube 9 with the second Luer taper 12, the other end of which is sealed connected to the collection container 16. The third opening 4 is sealed connected to the air filter 10 with the third Luer taper 13that is used to filter air entering the tube body 1 from outside to maintain the pressure balance in the tube body 1.

The enclosed centrifugation device further includes protective caps, and the openings are sealed connected to the corresponding protective caps respectively in a detachable way such as thread connection, snap connection. In the present embodiment, the first protective cap 17, the second protective cap 18 and the third protective cap 19 are sealed connected to the first opening 2, the second opening 3 and the third opening 4 respectively, by thread connection, snap connection, etc.

The enclosed centrifugation device further includes a protective cover 20, which is detachably connected to the middle part of the tube body 1, and the upper part of the tube body 1 is located inside the protected space between the protective cover 20 and the tube body 1. In the present embodiment, the protective cover 20 is detachably connected to the tubing body 1 by thread connection, etc.

In the method for cell segregation by using the enclosed centrifugation device of the present embodiment, the centrifugation force ranges between 200-500 g, so as to meet different application requirements. During centrifugation, the lower part of the tube body 1 is farther away from the centrifugation rotation center than the upper part of the tube body 1, making cells to be segregated enriched in the lower part of the tube body 1. The method consists of following steps:

The first opening 2 is sealed connected to one end of a liquid inlet tube 8, the other end of which is sealed connected to a sample container 15. The first opening 2 is switched to the open state, and sample to be centrifuged enters the tube body 1 from the sample container 15 passing through the liquid inlet tube 8. The working process of liquid inlet for the enclosed centrifugation device with three openings of the present embodiment is shown in FIG. 3.

1^{st} removal of protection and liquid inlet: the tube body 1 is kept upright, and the first protective cap 17 on the first opening 2 is removed. The first opening 2 is sealed connected to one end of the liquid inlet tube 8 by the first Luer taper 11, the other end of which is sealed connected to the sample container 15. The third protective cap 19 on the third opening 4 is removed, and the third opening 4 is sealed connected to the air filter 10 with the third Luer taper 13. The first valve 5 and the third valve 7 are opened and the second valve 6 is kept closed. Cell suspension, buffer, or other mixed fluid, etc. enters the tube body 1 passing through the first opening 2 by gravity or external force.

After liquid inlet: the first opening 2 is switched to the closed state, and the liquid inlet tube 8 is removed from the first opening 2. The third opening 4 is switched to the closed state and the air filter 10 is removed from the third opening 4. In the present embodiment, the first valve 5 and the third valve 7 are closed. The liquid inlet tube 8 is removed from the first opening 2 with the first Luer taper 11, and the air filter 10 is removed from the third opening 4 with the third Luer taper 13.

2^{nd} re-protection: the first protection cap 17 and the third protection cap 19 are set back on the first opening 2 and the third opening 4 respectively. The protective cover 20 is fixed connected to the tube body 1, and the openings are located inside the protected space between the protective cover 20 and the tube body 1.

Centrifugation: the enclosed centrifugation device is placed in a centrifuge for centrifugation. After centrifugation operation, the entire centrifugation device is removed from the centrifuge. The working process of centrifugation for the enclosed centrifugation device with three openings in the present embodiment is shown in FIG. 4.

The protective cover 20 is detachably connected to the tube body 1 by a thread connection, etc. Appropriate centrifugation parameters are selected, and the entire enclosed centrifugation device is placed on the bracket of a centrifuge for centrifugation, until an obvious cell clump 21 is formed near the tip of the cone as the lower part of the tube body 1. After centrifugation operation, the entire enclosed centrifuge device is removed from the centrifuge.

2^{nd} removal of protection: the protective cover 20, the second protective cap 18 on the second opening 3 and the third protective cap 19 on the third opening 4 are removed in sequence.

Liquid outlet: the second opening 3 is sealed connected to one end of the liquid outlet tube 9, the other end of which is sealed connected to the collection container 16, and the third opening 4 is sealed connected to the air filter 10 with the third Luer taper 13. The second opening 3 and the third opening 4 are switched to the open state. The tube body 1 is tilted so that liquid in the tube body 1 after centrifugation passes through the second opening 2, the liquid outlet tube 9 in sequence, and finally enters the collection container 16.

The working process of liquid outlet for the enclosed centrifugation device with three openings of the present embodiment is shown in FIG. 4 and FIG. 5.

The protective cover 20 on the tube body 1 and the second protective cap 18on the second opening 3 are removed, and the second opening 3 is sealed connected to one end of the liquid outlet tube 9 with the second Luer taper 12, the other end of which is sealed to the collection container 16. The third protective cap 19 on the third opening 4 is removed, and the third opening 4 is sealed connected to the air filter 10 with the third Luer taper 13.

One end of the second opening 3 is tilted downward, and the tube body 1 is tilted at a certain angle along the side of the tube wall configured to have the protrusion 14. The first valve 5 is kept closed, the second valve 6 is opened first, and then the third valve 7 is opened. Cell suspension, buffer, or mixed liquid to be electrotransferred, etc. enters the collection container 16 passing through the second opening 3 by gravity or external force. Meanwhile, the tube body 1 is gradually titled and the tilt angle is slowly increased, which ensures that cell suspension, buffer, or other mixed liquid, etc. in the tube body 1 always gathers near the second opening 3 until cell liquid, buffer, or other mixed liquid, etc. is completely discharged.

The protrusion 14 is used to prevent cell clumps 21 (particularly sand-like and discrete cells 22) near the tip of the cone as the lower part from sliding down the tube wall to the second opening 3.

After liquid outlet: the second opening 3 is switched to the closed state, and the liquid outlet tube 9 is removed from the second opening 3. The second opening 3 is switched to the closed state, from which the liquid outlet tube 9 is removed, and the third opening 4 is switched to the closed state, from which the air filter 10 is removed. In the present embodiment, the second valve 6 and the third valve 7 are closed, the liquid outlet tube 9 is removed from the second opening 3 with the second Luer taper 12, and the air filter 10 is removed from the third opening 4.

3^{rd} re-protection: the second protective cap 18 and the third protective cap 19 are set back on the second opening 3 and the third opening 4 respectively, the protective cover 20 is fixed connected to the tube body 1, and the openings are located inside the protected space between the protective cover 20 and the tube body 1. In this embodiment, the second protective cap 18 and the third protective cap 19 are set back on the second opening 3 and the third opening 4 respectively, and the protective cover 20 is fixed connected to the tube body 1 by thread connection.

The openings are switched between an open state and a closed state by the corresponding valve, which is not needed if the joint is a needle-free joint.

If it is necessary to carry out “liquid inlet → centrifugation → liquid outlet” process for many times, the corresponding work process can be repeated.

### Embodiment 2

In this embodiment, the enclosed centrifugation device of the present invention is used for centrifugation, and Jurkat cells are used for enrichment test by centrifugation.

RPMI 1640 culture medium supplemented with 10% (v/v) fetal bovine serum was used for cell culture at a density of 0.2-3 × 10⁶/mL. Prior to the test, cells were counted and viability was tested by APC-Annexin V/7AAD staining and flow cytometry analysis. The total cell density was 2.32×10⁶/mL, and Annexin V-/7AAD-proportion of living cells was 96.5%.

Using the enclosed centrifugation device of embodiments of the present invention (hereinafter referred to as the first centrifugation device), and a conventional open-cap centrifugation device (hereinafter referred to as the second centrifugation device), 150 mL of cell culture was collected, and centrifuged for 3 min and 5 min at a centrifugal force of 200 g, 250 g, and 300 g respectively. After centrifugation, the supernatant in the centrifugation devices was discarded by inverting the centrifuge tube, then cells of each group were re-suspended with 150 mL culture medium and thereafter were counted and analyzed for viability (Table 1).

TABLE 1

First centrifugation device

| Centrifugation parameter (Centrifugation force and time) | 200 g, 3 min | 200 g, 5 min | 250 g, 3 min | 250 g, 5 min | 300 g, 3 min | 300 g, 5 min |
|---|---|---|---|---|---|---|
| Total cell density (×10⁶ cell/mL) | 2.11 | 2.28 | 2.18 | 2.27 | 2.27 | 2.30 |
| Viability (%) | 92.4 | 91.8 | 92.4 | 92.2 | 92.3 | 92.6 |

Second centrifugation device

| | | | | | | |
|---|---|---|---|---|---|---|
| Total cell density (× 10⁶/ cell/mL) | 2.07 | 2.34 | 2.20 | 2.26 | 2.24 | 2.28 |
| Viability (%) | 92.4 | 91.6 | 92.3 | 92.7 | 91.9 | 92.2 |

The results as shown in Table 1, under the same centrifugation conditions, there was no significant difference in cell density after re-suspension between the corresponding groups using the two centrifugation devices, which indicated that there was no significant difference in enrichment result by centrifugation. Compared to the conventional centrifugation method, the centrifugation device of embodiments of the present invention does not cause a decrease in cell viability due to a longer operation time, and there is no significant difference in cell viability among the groups.

### Embodiment 3

The present embodiment provides another enclosed centrifugation device (FIGS. 7-9), comprising an integrated tube body 1 that includes an upper part, a middle part and a lower part, wherein two ends of the middle part are fixed connected to the upper part and the lower part respectively, or, the upper part, the middle part and the lower part are integrally injection molded, and the upper part is configured to have multiple openings that are used for sealed connection to external tubing, and include,

the first opening 2 serving as a liquid inlet having an open state and a closed state, which is used for sealed connection to a liquid inlet tube 8. The second opening 3 serving as a liquid outlet having an open state and a closed state, which is used for sealed connection to a liquid outlet tube 9. The openings in the present embodiment further includes the third opening 4 serving as a vent having an open state and a closed state, which is used for sealed connection to the air filter 10 as an air filtering device, and the fourth opening 28 used as another liquid outlet having an open state and a closed state, which is used for sealed connection to a liquid suction tube 30 serving as a liquid outlet tube with the fourth needle-free joint 28. Specifically, the overall structure of the enclosed centrifugation device with four openings is shown in FIG. 7 and FIG. 8.

The enclosed centrifugation device comprises a tube body 1, the first opening (liquid inlet) 2, the second opening (liquid outlet) 3, the third opening (vent) 4, fourth needle-free joint (another liquid outlet) 28, the liquid inlet tube 8, the liquid outlet tube 9, the air filter 10, the sample container 15, the liquid suction tube 27, the liquid suction tube 30, the collection container 16, the negative pressure collection device 29, the first needle-free joint 23, the second needle-free joint 24, the third needle-free joint 25, the fourth needle-free joint 26, the first protective cap 17, the second protective cap 18, the third protective cap 19, the fourth protective cap 31 and the protective cover 20.

The upper part of the tube body 1 is cone-shaped protruding upward, the lower part of the tube body 1 is cone-shaped protruding downward, and the middle part of the tube body 1 is cylinder-shaped. In this embodiment, if the tube body 1 is made of soft material that is selected from silicone, rubber, PET, PE, PVC, TPU, PPS, TPE, etc., the enclosed centrifugation device does not include the third opening 4 serving as a vent, and the tube body lis integrally embedded inside the protective cover 20. At least one connecting part is placed between the protective cover 20 and the tube body 1 to achieve detachable connection between the protective cover 20 and the tube body 1, wherein one end of the connecting part is connected to the protective cover 20, and the other end of the connecting part is detachably connected to the tube body 1. In the present embodiment, the opening (such as the first opening 2, the second opening 3, the third opening 4, or the fourth opening 28) is configured to have a step edge, where connection between the other end of the connecting part and the tube body is located.

The protective cover 20 is configured to have a fixing structure, with which one end of the connecting part is connected to the protective cover 20. The fixing structure is a hole located on the protective cover 20, or, the fixing structure is a hook or a fixing base that is fixed connected to the protective cover 20. The connecting part is selected from a string, a cable tie, a magic tape, a clasp, etc.

The first opening 2, the second opening 3, the third opening 4 and the fourth opening 28 are all located on the same side of cone of the tube body 1 (i.e. the cone as the upper part) the second opening 3 is located at the tip of the cone as the upper part, and the first opening 2, the third opening 4 and the fourth opening 28 are located on the side wall of the cone as the upper part,

The first opening 2, the second opening 3 and the third opening 4 are sealed connected to the liquid inlet tube 8, the liquid outlet tube 9 and the air filter 10 respectively, with the first needle-free joint 23, the first needle-free joint 24 and the first needle-free joint 25. The air filter 10 is used to filter air entering the tube body 1 from outside to maintain the pressure balance in the tube body 1. The fourth opening 28 is sealed connected to the liquid suction tube 30 with the fourth needle-free joint 26. The negative pressure collection device 29 can be selected from a syringe, a pipette, a container with a negative pressure pump, etc.

The liquid suction tube 27 is configured in the tube body 1, one end of which is connected to the fourth opening 28. In the present embodiment, one end of the liquid suction tube 27 is sealed connected to the fourth opening 28, the other end of which is located at the junction of the middle part and the lower part.

The enclosed centrifugation device further includes protective caps, and the openings are sealed connected to the corresponding protective caps respectively in a detachable way such as thread connection, snap connection. In the present embodiment, the first protective cap 17, the second protective cap 18, the third protective cap 19 and the fourth protective cap 31 are sealed connected to the first opening 2, the second opening 3, the third opening 4 and the fourth opening 28 respectively, by thread connection or snap connection, etc.

The tube body 1 and the protective cover 20 can be injection molded by using molds, so that the tube body 1 can be embedded inside the protective cover 20 during assembly.

All the openings of the enclosed centrifugation device are in the closed state and are configured to have a protective cap respectively. The protective cover 20 is detachably connected to the tube body 1that is embedded inside the protective cover 20, and the tube walls of the two are in fit with each other (FIG. 8).

The whole working process of centrifugation for the enclosed centrifugation device with four openings in the present embodiment (FIGS. 7-9) includes following steps:

1^{st} removal of protection: the protective cover 20 and the protective caps on the first opening 2 and the third opening 4 are removed in sequence.

Liquid inlet: the first opening 2is sealed connected to one end of the liquid inlet tube 8, the other end of which is sealed connected to the sample container 15. The third opening 4 is sealed connected to the air filter 10 used for filtering air that enters the tube body from outside. The first opening 2 and the third opening4 are switched to the open state respectively, and sample to be centrifuged enter the tube body 1 from the sample container 15 passing through the liquid inlet tube 8.

After liquid inlet: the first opening 2 and the third opening 4 are switched to the closed state respectively. The liquid inlet tube 8 is removed from the first opening 2, and the air filter 10 is removed from the third opening 4.

2^{nd} re-protection: the protection caps are set back on the first opening 2 and the third opening 4 respectively. The protective cover 20 is fixed connected to the tube body 1, and the openings are located inside the protected space between the protective cover 20 and the tube body 1. The protective cover 20 is fixed connected to the tube body 1 that is made of soft material by a connecting part such as a string, a cable tie, a magic tape, and a clasp, and the fixing structure on the protective cover 20 is a hole, or a hook or a fixing base that is fixed connected to the protective cover 20 by thread connection. One end of the connecting part is connected to the fixing structure, and the other end of the connecting part is connected to the step edge at an opening of the tube body 1.

Centrifugation: the enclosed centrifugation device is placed in a centrifuge for centrifugation. After centrifugation operation, the entire centrifugation device is removed from the centrifuge.

2^{nd} removal of protection: the protective cover 20, the connecting part, and the protective caps on the fourth opening 28 and the third opening 4 are removed in sequence, and the fourth opening 28 is sealed connected to the liquid suction tube 27 in the pipe body 1.

Liquid outlet: the fourth opening 28 is sealed connected to one end of the liquid suction tube 30, the other end of which is sealed connected to a negative pressure collection device 29. The third opening 4 is sealed connected to the air filter 10 used for filtering air that enters into the tube body 1 from the outside. The third opening 4 and the fourth opening 28 are switched to the open state respectively, and the tube body 1 is tilted so that liquid in the tube body 1 after centrifugation passes through the fourth opening 28 and the liquid suction tube 30 in sequence, and finally enters the negative pressure collection device 29.

After liquid outlet: the third opening 4 and the fourth opening 28 are switched to the closed state respectively, the air filter 10 is removed from the third opening 4, and the liquid suction tube 30 is removed from the fourth opening 28.

3rd re-protection: the protective caps are set back on the third opening 4 and the fourth opening 28 respectively. The protective cover 20 is fixed connected to the tubing body 1, and the openings are located inside the protected space between the protective cover 20 and the tube body 1.

The whole working process of centrifugation for the enclosed centrifugation device with four openings in the present embodiment (FIGS. 7-9) is briefly described as follows (similar to Embodiment 1):

Cell suspension, buffer, or other mixed liquid, etc. in the sample container 15 is introduced into the tube body 1 passing through the liquid inlet tube 8 that is then removed, and the tube body 1 is integrally embedded inside the protective cover 20. The entire enclosed centrifugation device is placed on the bracket of a centrifuge for centrifugation, until obvious cell enrichment occurs near the tip of the cone as the lower part of the tube body 1. After centrifugation operation, the entire enclosed centrifuge device is removed from the centrifuge.

Next, the fourth opening 28 is sealed to the negative pressure collection device 29 with the liquid suction tube 30, and the tube body 1 is placed at an appropriate angle, so as to make the bottom end of the liquid suction tube 27 throughout in contact with cell suspension, buffer or other mixed fluid, etc., which is quickly sucked by using the force generated by negative pressure collection device 29until liquid is sucked up completely, achieving the purpose of cell segregation in an enclosed setting.

In the above working process, similar to Embodiment 1,after the liquid inlet tube 8, the liquid outlet tube 9, the air filter 10 or the liquid suction tube 30 are removed from the entire enclosed centrifugation device, the first protective cap 17, the second protective cap 18, the third protective cap 19, or the fourth protective cap 31 is immediately set back on the first opening 2, the second opening 3, the third opening 4, or the fourth opening 28 correspondingly.

If it is necessary to carry out “liquid inlet → centrifugation → liquid outlet” process for many times, the corresponding work process can be repeated.

### Embodiment 4

The enclosed centrifugation device in the present embodiment differs from Embodiment 3 in that the top end of the upper part is flat (FIG. 10).

### Embodiment 5

The closed centrifugation device in the present embodiment differs from Embodiment 1 in that the first opening (liquid inlet) 2 and the third opening (vent) 4 are located on the same side of the second opening (liquid outlet) 3.

Although the present invention has been disclosed in the form of embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. An enclosed centrifugation device, comprising:
an integrated tube body including an upper part, a middle part, and a lower part, wherein two ends of the middle part are fixedly connected to the upper part and the lower part respectively, or, the upper part, the middle part, and the lower part are integrally injection molded, and the upper part is configured to have a plurality of openings which include:
a first opening serving as a liquid inlet, which is used for a sealed connection to a liquid inlet tube and has an open state and a closed state and
a second opening serving as a liquid outlet, which is used for a sealed connection to a liquid outlet tube and has an open state and a closed state.

2. The enclosed centrifugation device according to claim 1, wherein the openings further include a third opening serving as a vent, which is used for sealed connection to an air filtering device and has an open state and a closed state.

3. (canceled)

4. (canceled)

5. The enclosed centrifugation device according to claim 1, wherein the inner part of the integrated tube body is configured to have a protrusion, which is used to block cell clumps in the integrated tube body.

6. The enclosed centrifugation device according to claim 41, wherein the lower part is a cone protruding downward, a side wall of the cone as the lower part is configured to have a protrusion, which is used to block cell clumps near a tip of the cone as the lower part.

7. The enclosed centrifugation device according to claim 5, wherein the protrusion is distributed along a horizontal plane.

8. The enclosed centrifugation device according to claim 5, wherein a width of the protrusion ranges between 0.2 cm-1.5 cm, and a length of the protrusion ranges between ⅓ - ½ of a circumference of the integrated tube body at a corresponding position of the protrusion.

9. The enclosed centrifugation device according to claim 8, wherein the width of the protrusion is about 0.6 cm, and the length of the protrusion is about ⅓ of the circumference of the integrated tube body at the corresponding position of the protrusion.

10. The enclosed centrifugation device according to claim 1, wherein the upper part is a cone protruding upward and the second opening is located at a tip of the cone as the upper part.

11. The enclosed centrifugation device according to claim 2, wherein the upper part is a cone protruding upward, the second opening is located at a tip of the cone as the upper part, and the first opening and the third opening are located on a side wall of the cone as the upper part; further wherein the first opening and the third opening are located on one side of the second opening respectively, or, the first opening and the third opening are located on the side of the second opening.

12. (canceled)

13. The enclosed centrifugation device according to claim 1, wherein the integrated tube body is configured to have a liquid suction tube, one end of which is connected to the liquid outlet; the lower part is a cone protruding downward, and the other end of the liquid suction tube is located at a junction of the middle part and the lower part, or, the other end of the liquid section tube is located on the side wall of the cone as the lower part.

14. (canceled)

15. (canceled)

16. (canceled)

17. The enclosed centrifugation device according to claim 10, wherein the plurality of openings further include a third opening serving as a vent and a fourth opening, the lower part is a cone protruding downward, and the fourth opening is connected to one end of the liquid suction tube, the other end of which is located at a junction of the middle part and the lower part, or, is located on the inner side wall of the cone as the lower part.

18. The enclosed centrifugation device according to claim 11, wherein the second opening is located at the tip of the cone as the upper part, and the first opening, the third opening and the fourth opening are located on the side wall of the cone as the upper part, wherein the first opening, the third opening are located on one side relative to the second opening, and the fourth opening is located on the other side relative to the second opening.

19. The enclosed centrifugation device according to claim 1, further comprising a protective cover, which is detachably connected to the integrated tube body, and when the protective cover is connected to the integrated tube body, the plurality of openings are located inside a protected space between the protective cover and the integrated tube body.

20. The enclosed centrifugation device according to claim 13, wherein a protective cover is detachably connected to the middle part of the enclosed centrifugation device, the upper part of the enclosed centrifugation device is located inside a protected space; further wherein the integrated tube body is integrally embedded inside the protective cover; and a tube wall of the integrated tube body is fit with the tube wall of the protective cover.

21. (canceled)

22. (canceled)

23. (canceled)

24. (canceled)

25. (canceled)

26. (canceled)

27. The enclosed centrifugation device according to claim 1, wherein the integrated tube body is made of hard material and/or soft material, wherein the hard material is selected from ceramics, glass, ABS, PC, PS, PA, POM, and PMMMA, and the soft material is selected from silicone, rubber, PET, PE, PP, PVC, TPU, PU, PPS, and TPE.

28. The enclosed centrifugation device according to claim 1, wherein the integrated tube body is made of soft material that is selected from silicone, rubber, PET, PE, PVC, TPU, PPS, and TPE, and the enclosed centrifugation device does not include the opening serving as a vent; the enclosed centrifugation device funher comprises a protective cover which is detachably connected to the tube body; the tube body is integrally embedded inside the protective cover; at least one connecting part is placed between the protective cover and the tube body to achieve detachable connection between the protective cover and the tube body, wherein one end of the connecting part is connected to the protective cover, and the other end of the connecting part is detachably connected to the tube body; the protective cover is configured to have a fixing structure, with which one end of the connecting part is connected to the protective cover.

29. (canceled)

30. (canceled)

31. (canceled)

32. The enclosed centrifugation device according to claim 1, wherein the fixing structure is a hole located on the protective cover, or, the fixing structure is a hook or a fixing base that is fixed connected to the protective cover, and the connecting part is selected from a string, a cable tie, a magic tape and a clasp.

33. A method for cell segregation by using an enclosed centrifugation device according to claim 1, wherein all the plurality of openings are in a closed state and are configured to have a protective cap respectively, a protective cover is fixed connected to the integrated tube body, and the plurality of openings are located inside a protected space between the protective cover and the integrated tube body, the method comprising:
a first removal of protection: removing the protective cover and the protective cap on the first opening in sequence;
a liquid inlet: sealingly connecting the first opening to one end of the liquid inlet tube, and sealed connect the other end of the liquid inlet tube to a sample container; switching the first opening to the open state, and liquid sample to be centrifuged enters the integrated tube body from the sample container passing through the liquid inlet tube;
After liquid inlet: switching the first opening to the closed state, and remove the liquid inlet tube from the first opening;
second re-protection: setting back the protective cap on the first opening, and fixedly connecting the protective cover to the tube body, so that the plurality of openings are located inside a protected space between the protective cover and the integrated tube body;
centrifugation: placing the enclosed centrifugation device in a centrifuge for centrifugation; second removal of protection: removing the protective cover and the protective cap on the second opening in sequence;
liquid outlet: sealingly connecting the second opening to one end of the liquid outlet tube, and sealed connect the other end of the liquid outlet tube to a collection container; switching the second opening to the open state, and tilting the integrated tube body so that liquid in the integrated tube body after centrifugation flows passing through the second opening and the liquid outlet tube successively, and finally enters the collection container;
after liquid outlet: switching the second opening to the closed state, and removinge the liquid outlet tube from the second opening;
third re-protection: setting back the protective cap on the second opening, and fixedly connecting the protective cover to the tube body, so that the openings are located inside a protected space between the protective cover and the integrated tube body.

34. The method according to claim 18, wherein the plurality of openings further include the third opening serving as a vent, which is in a closed state and covered by a protective cap;
in the step of “first removal of protection”: removing the protective cap on the third opening;
in the step of “a liquid inlet”: sealingly connecting the third opening to the air filtering device for filtering air that enters the tube body from outside, and switching the third opening the open state;
in the step of “after liquid inlet”: switching the third opening to the closed state, and removing the air filtering device from the third opening;
in the step of “second re-protection”: set back the protection cap on the third opening;
in the step of “second removal of protection”: removing the protective cap on the third opening;
in the step of “liquid outlet”: sealingly connecting the third opening to the air filtering device for filtering air that enters into the tube body from outside; switching the second opening to the open state, and then switching the third opening to the open state;
in the step of “after liquid outlet”: switching the third opening to the closed state, and removing the air filtering device from the third opening; and
in the step of “third re-protection”: setting back the protective cap on the third opening.

35. A method for cell segregation by using an enclosed centrifugation device according to claim 1, wherein all the plurality of openings are in a closed state and each is configured to have a protective cap respectively, the protective cover is fixed connected to the integrated tube body, and the plurality ofopenings are located inside a protected space between the protective cover and the integrated tube body; the method comprising:
first removal of protection: removing the protective cover and the protective caps on the first opening and the third opening in sequence;
a liquid inlet: sealingly connecting the first opening to one end of a liquid inlet tube, sealed connect the other end of the liquid inlet tube to a sample container, and sealingly connecting the third opening to an air filtering device for filtering air that enters the tube body from outside;
switching the first opening and the third opening to the open state respectively, and liquid sample to be centrifuged enters the tube body from the sample container passing through the liquid inlet tube;
after liquid inlet: switching the first opening and the third opening to the closed state respectively, removing the liquid inlet tube from the first opening, and removing the air filtering device from the third opening;
second re-protection: setting back the protection caps on the first opening and the third opening respectively, and fixedly connecting the protective cover to the integrated tube body, so that the openings are located inside a protected space between the protective cover and the integrated tube body;
centrifugation: placing the enclosed centrifugation device in a centrifuge for centrifugation;
second removal of protection: removing the protective cover, the connection part, and the protective caps on the fourth opening and the third opening in sequence, and sealingly connecting the fourth opening to the liquid suction tube in the integrated tube body;
liquid outlet: sealingly connecting the fourth opening to one end of the liquid outlet tube, sealingly connecting the other end of the liquid outlet tube to a negative pressure collection device, and sealingly connecting the third opening to an air filtering device for filtering air that enters into the integrated tube body from outside; switching the third opening and the fourth opening to the open state respectively, and tilting the integrated tube body so that liquid in the integrated tube body after centrifugation flows passing through the fourth opening and the liquid outlet tube successively, and finally enters the negative pressure collection device;
after liquid outlet: switching the third opening and the fourth opening to the closed state respectively, removing the air filtering device from the third opening, and removing the liquid outlet tube from the fourth opening; and
third re-protection: setting back the protective caps on the third opening and the fourth opening respectively, and fixedly connecting the protective cover to the integrated tube body, so that the openings are located inside a protected space between the protective cover and the integrated tube body.

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)
